(19) United States
(12) Patent Application Publication
(10) Pub. No.: US 2009/0128507 A1
(43) Pub. Date: May 21, 2009

(54) DISPLAY METHOD OF INFORMATION DISPLAY DEVICE

(76) Inventors: Takeshi HOSHINO, Kodaira (JP); Tatsuya Tokunaga, Tokyo (JP); Masashi Ichifuru, Mitaka (JP); Manabu Yanagimoto, Kawasaki (JP); Masaki Takano, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/194,024

(22) Filed: Aug. 19, 2008

(30) Foreign Application Priority Data
Sep. 27, 2007 (JP) 2007-250373
Mar. 31, 2008 (JP) 2008-089137

(51) Int. Cl. G06F 3/041; G09G 3/20

(52) U.S. Cl. 345/173; 345/55

(57) ABSTRACT

The information display apparatus is equipped with: a display unit for displaying a plurality of choice items in the list form; a control unit for controlling an array of the choice items; and a track ball for instructing a coordinate signal. The choice items are displayed in a matrix array constructed of N rows M columns in which the choice items are sequentially arranged from an upper portion to a lower portion of said matrix array, and along right and left directions thereof; magnification is changed based upon a coordinate signal of the track ball along a Y-axis direction; a display screen is scrolled along right/left directions based upon a coordinate signal of the track ball along an X-axis direction; and the matrix array is changed based upon a number of rows to be displayed in correspondence with increased/decreased numbers of the rows.

### INCORPORATION BY REFERENCE

The present application claims priorities from Japanese applications JP 2007-250373 filed on Sep. 27, 2007, JP 2008-089137 filed on Mar. 31, 2008, the contents of which are hereby incorporated by reference into this application.

### BACKGROUND OF THE INVENTION

1. Field of the Invention

The present invention is related to a display method of an information display apparatus, in which while a selection screen such as a menu screen, an operation screen, and the like which are equipped with a plurality of operation buttons is displayed on a display screen, a cursor is moved by operating a pointing device so as to execute various sorts of operations displayed on the above-described selection screen.

2. Description of the Related Art

Very recently, in personal computers and various sorts of information display apparatuses, there are many possibilities that various sorts of operations are instructed by operating keyboards and/or manipulating mousses. To this end, while menu screens and operation screens equipped with a plurality of operation buttons are displayed on display apparatuses, a cursor is moved to a target operation button, or an operation button which is desirably selected so as to perform a decision operation. Generally speaking, mousses are usually employed as means for moving this cursor. This mouse is equipped with a track ball mechanism mounted on a bottom plane of a mouse main body which is gripped by a user. Since the mouse main body is moved over a plane of an operation table so as to rotate a ball of the above-described track ball mechanism, operations corresponding to a move amount and a move direction of the ball are converted into a move amount and a move direction of the cursor. However, as to this mouse, in order that the mouse main body is directly moved, the operation table plane is absolutely required. More specifically, in such a case that the cursor is moved over a long distance, the below-mentioned operations must be repeatedly carried out: That is, the mouse main body is moved from a point “A” to another point “B”; this mouse main body is once picked up, and then, is returned to the point “A”; and thereafter, the mouse main body is again moved to the point “B”, namely, a so-called “rowing operation” must be repeatedly carried out.

As an apparatus capable of solving such a demerit of a mouse, a track ball has been utilized. This track ball has been equipped with such a structure that while a mouse is reversed, a ball is exposed from an upper plane thereof. In accordance with this track ball, the track ball main body can be provided in a fixed manner; and the ball arranged on the upper plane of this track ball main body can be moved along an arbitrary direction by a finger tip of an operator, so that the cursor on the display screen can be simply moved. As a result, even when the operation table plane is not provided, the track ball can realize similar operations to those of the mouse.

In addition, a touch pad which senses a move amount of a position touched by a finger tip of an operator and then converts the sensed move amount into a move amount of a cursor may also be known as a pointing device operable without an operation table plane. The above-described pointing device is disclosed in, for example, JP-A-2004-272630.

Also, very recently, since digital broadcasting systems have been popularized and also various sorts of contents have been digitally processed, large amounts of information have been displayed on display screens of television receivers. However, in these television receivers, while one of plural choice items is brought into a focused status, this focused choice item is moved by a cross-shaped key provided on a remote controller, so that a desirable choice item can be selected.

However, since only one choice item is merely moved by operating the cross-shaped key of the remote controller, in such a case that a large amount of focused choice items are wanted to be moved, an operator must manipulate the cross-shaped key many times.

Under such a circumstance, as conventional techniques, various sorts of technical ideas have been proposed in order that EPG operations under digital broadcast environment and scrolling operations in connection with these EPG operations may be carried out in higher speeds with simpler operations as being permitted as possible, and further, users may perform comfortable operations without skilled techniques of these users. That is, track pad units are provided in remote controllers; movable means are employed in the remote controllers, which are operated as slave operations in response to master operations of the track pad units; and also, switch means for performing switching operations in response to either depressing operations or sliding operations of the track pad units are provided in the remote controllers. These conventional techniques have been disclosed in, for example, JP-A-2003-348370.

As previously described since the track balls do not require any operation table plane, these track balls have such a merit that information appliances are operated under such an installation condition having no work space, and operation units are directly provided in appliances. However, in the track ball, the move operation of the mouse main body is not interconnected with the movement of the cursor, which is different from the mouse operation. When the track ball is moved to a certain point on a display screen, the user cannot commence the track ball operation by previously predicting a rotation distance of the ball. In other words, in the track ball, while the track ball main body is fixed, the coordinates instruction is carried out by rotating the ball. As a result, there is a problem that a corresponding relation between the rotations of the ball and the move distances can be hardly established. In particular, in such a case that a move distance of a cursor is short, the track ball may be manipulated with having the same feelings as those of the mouse. However, if a move distance of the cursor becomes long, then the track ball is firstly moved over a proper distance, and thereafter, a fine control of this move distance must be carried out after the operator can view a goal point.

In particular, when a track ball is utilized, this track ball has the following operability. That is, an operator can largely manipulate the track ball along the right/left directions while a wrist of this operator is set as an axis as to lateral motion, whereas motion of his wrist along a longitudinal direction is restricted within such a range where his fingers are bent/stretched, so that the operator can hardly manipulate the ball along the longitudinal direction, for instance, linear movement of this track ball along the Y-axis direction and the X-axis direction can be hardly performed.

Also, with respect to a pointing device such as a touch pad mounted on a remote operation apparatus, which is manipulated by using only a specific finger tip of an operator under such a condition that the operator grips the pointing device by his hand, this pointing device has such an operability that a manipulation along the longitudinal direction is restricted, as compared with a manipulation along the right/left directions.

On the other hand, as to various sorts of contents retrieving screens, the below-mentioned requirements are issued: That is, while a large number of choice items such as operation buttons and icons are displayed on a display screen in a list form, a specific choice item is wanted to be enlarged so as to confirm a content of this enlarged choice item. Otherwise, it is required to have a bird's-eye view of an entire content retrieving screen, or to scroll the content retrieving screen.

In addition, in accordance with the above-described track pad of the conventional technique, although the technical idea of this track pad may be employed in a fixed table type list such as an EPG (Electronic Program Guide), this conventional technical idea cannot be properly applied to such a retrieving operation, while contents are visually confirmed by enlarging and/or reducing a large amount of thumbnails and icons.

### SUMMARY OF THE INVENTION

As a consequence, an object of the present invention is to provide a display method of an information display apparatus, capable of displaying a plurality of choice items in a list form by enlarging and/or reducing these choice items, while properly utilizing operability as to track ball and pointing device of a remote operation apparatus.

Furthermore, another object of the present invention is to provide a display method of an information display apparatus capable of retrieving a large amount of thumbnails and icons, while these thumbnails and icons can be enlarged and/or reduced so as to display the enlarged/reduced thumbnails and icons in a list form.

To achieve the above-described objects, in a display method of an information display apparatus according to an aspect of the present invention, while the above-described information display apparatus is provided with: a display apparatus for displaying thereon a plurality of choice items in a list form; a control apparatus for controlling an array of the choice items of the display apparatus; and a remote operation apparatus equipped with a track ball for instructing a coordinate signal with respect to the control apparatus, the choice items are displayed on the display apparatus in a matrix array constructed of N rows M columns in which the choice items are sequentially arranged from an upper portion to a lower portion of the matrix array, and further, along right and left directions thereof; magnification is changed based upon a coordinate signal of the track ball along a Y-axis direction; a display screen of the display apparatus is scrolled along the right/left directions based upon a coordinate signal of the track ball along an X-axis direction; and the matrix array is changed based upon a number of rows to be displayed in correspondence with increased/decreased numbers of the rows to be displayed in connection with the change in the magnification.

Also, in a display method of an information display apparatus according to another aspect of the present invention, while the above-explained information display apparatus is provided with: a display apparatus for displaying thereon a plurality of choice items in a list form; a control apparatus for controlling an array of the choice items of the display apparatus; and a remote operation apparatus equipped with a pointing device for instructing a coordinate signal with respect to the control apparatus, the pointing device being operated by a finger tip of a user under gripped condition thereof, the choice items are displayed on the display apparatus in a matrix array constructed of N rows M columns in which the choice items are sequentially arranged from an upper portion to a lower portion of the matrix array, and further, along right and left directions thereof; magnification is changed based upon a coordinate signal of the pointing device along a Y-axis direction; a display screen of the display apparatus is scrolled along the right/left directions based upon a coordinate signal of the pointing device along an X-axis direction; and the matrix array is changed based upon a number of rows to be displayed in correspondence with increased/decreased numbers of the rows to be displayed in connection with the change in the magnification.

Furthermore, according to a further aspect of the present invention, in such a display method that a plurality of choice items are displayed on a display screen in a list form in a matrix array constructed of N rows M columns in which the choice items are sequentially arranged from an upper portion to a lower portion of the matrix array, and further, along right and left directions thereof; and based upon an operation instruction issued from a coordinate instructing apparatus, a specific choice item is selected from the plurality of choice items displayed in the list form, upon receipt of an operation signal of switching unit which switches coordinate signals of the coordinate instructing apparatus into a first mode and a second mode, in the first mode, magnification is changed based upon a coordinate signal of a Y-axis direction; the display screen is scrolled along right/left directions based upon a coordinate signal of an X-axis direction; and an array of the list display is changed based upon a number of rows to be displayed in correspondence with increased/decreased numbers of the rows to be displayed in connection with the change in the magnification; and in the second mode, while the choice item at a predetermined position of a preset list display is brought into a focused status, the focused status is moved based upon the coordinate signals of the Y-axis direction and the X-axis direction.

In accordance with the present invention, superior operability which is fitted to the operation characteristics as to the track ball and the pointing device of the remote operation apparatus can be provided, while the choice items are displayed in the list form in the enlarged/reduced modes.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram for conceptionally showing a television receiver according to a first embodiment of the present invention.

FIG. 2 is a block diagram for indicating an arrangement of the television receiver shown in FIG. 1.

FIG. 3 is a flow chart for describing a contents retrieving flow operation of the television receiver of FIG. 1.

FIG. 4 illustratively shows a contents retrieving screen of the television receiver of FIG. 1.

FIG. 5 is a flow chart for describing a contents viewing flow operation of the television receiver of FIG. 1.

FIG. 6A to FIG. 6B are array diagrams of contents viewing screens provided in the television receiver of FIG. 1.

FIG. 7A to FIG. 7D are array diagrams of contents viewing screens provided in the television receiver of FIG. 1.

FIG. 8 is a diagram for conceptionally showing a television receiver according to a second embodiment of the present invention.

FIG. 9 is a block diagram for indicating an arrangement of the television receiver shown in FIG. 8.

FIG. 10 is a flow chart for describing a contents retrieving flow operation of the television receiver of FIG. 8.

FIG. 11 illustratively shows a contents retrieving screen of the television receiver of FIG. 8.

FIG. 12 is a flow chart for describing a contents viewing flow operation of the television receiver of FIG. 8.

FIG. 13A to FIG. 13E are array diagrams of contents viewing screens provided in the television receiver of FIG. 8.

FIG. 14 is an array diagram of a contents viewing screen provided in the television receiver of FIG. 8.

FIG. 15 is a flow chart for describing a contents viewing flow operation of the television receiver of FIG. 8.

FIG. 16A to FIG. 16B are array diagrams of contents viewing screens provided in the television receiver of FIG. 8.

FIG. 17A to FIG. 17D are array diagrams of contents viewing screens provided in the television receiver of FIG. 8.

### DETAILED DESCRIPTION OF THE INVENTION

### First Embodiment

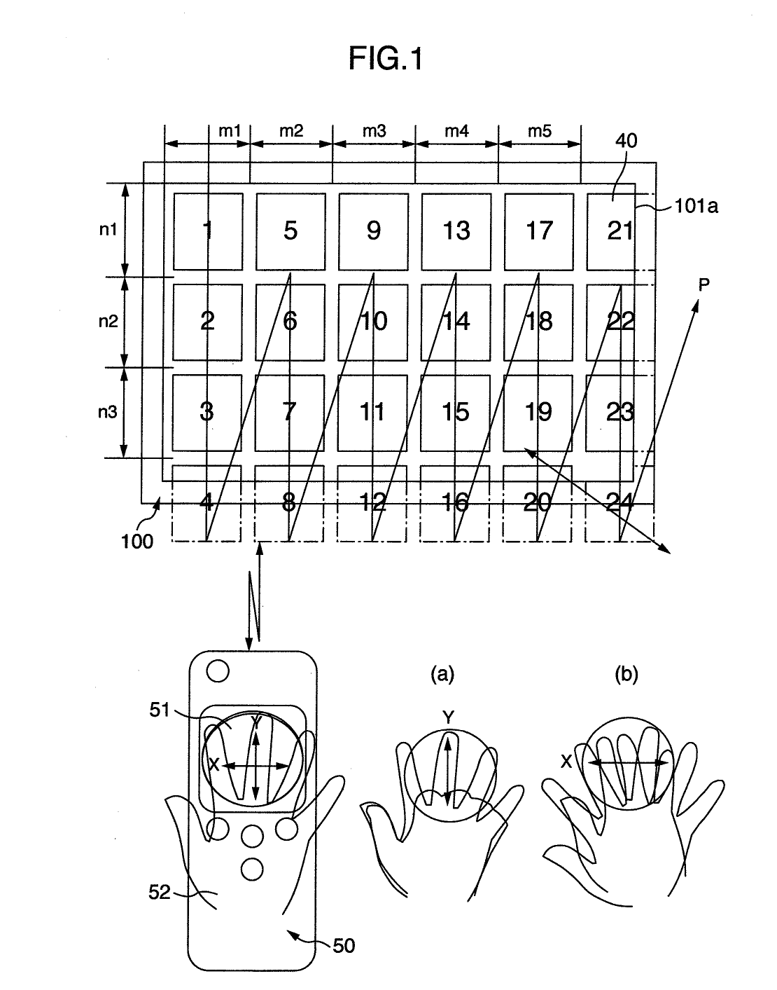

Referring now to FIG. 1 to FIG. 7, a concrete description is made of an information display apparatus according to a first embodiment of the present invention.

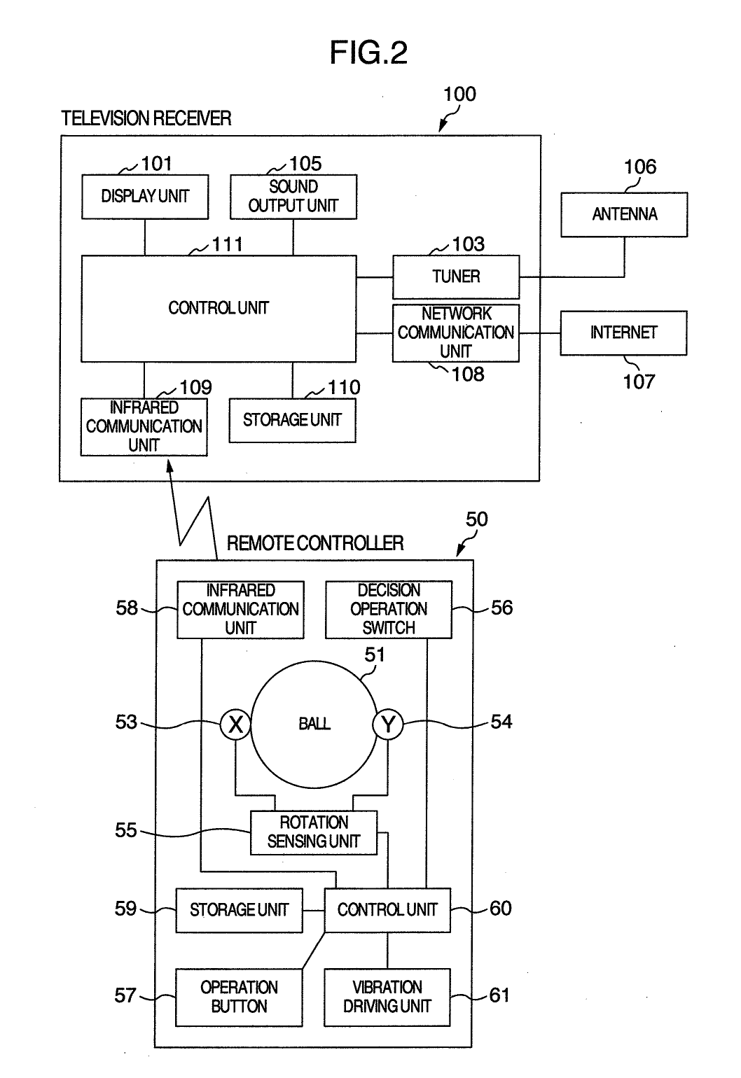

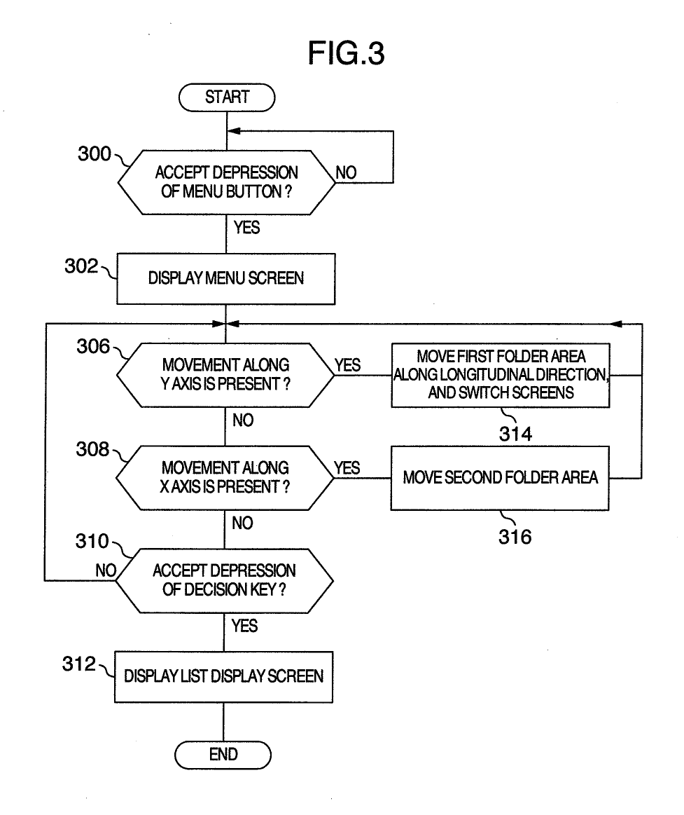

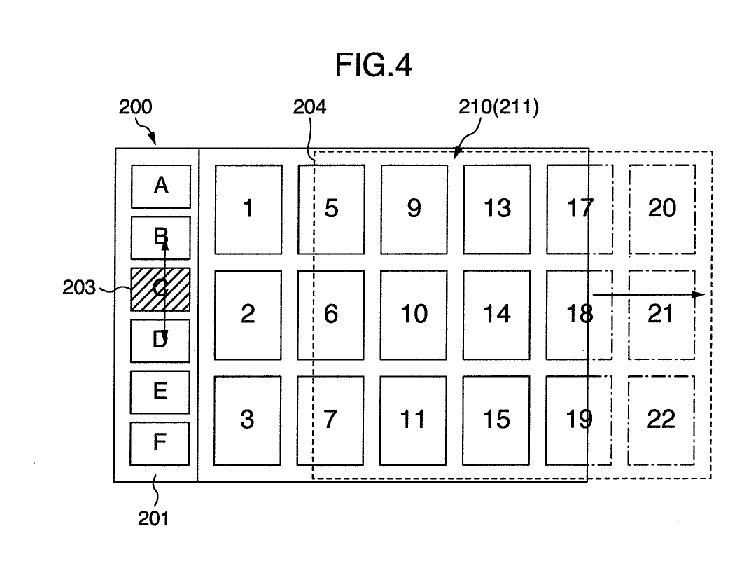

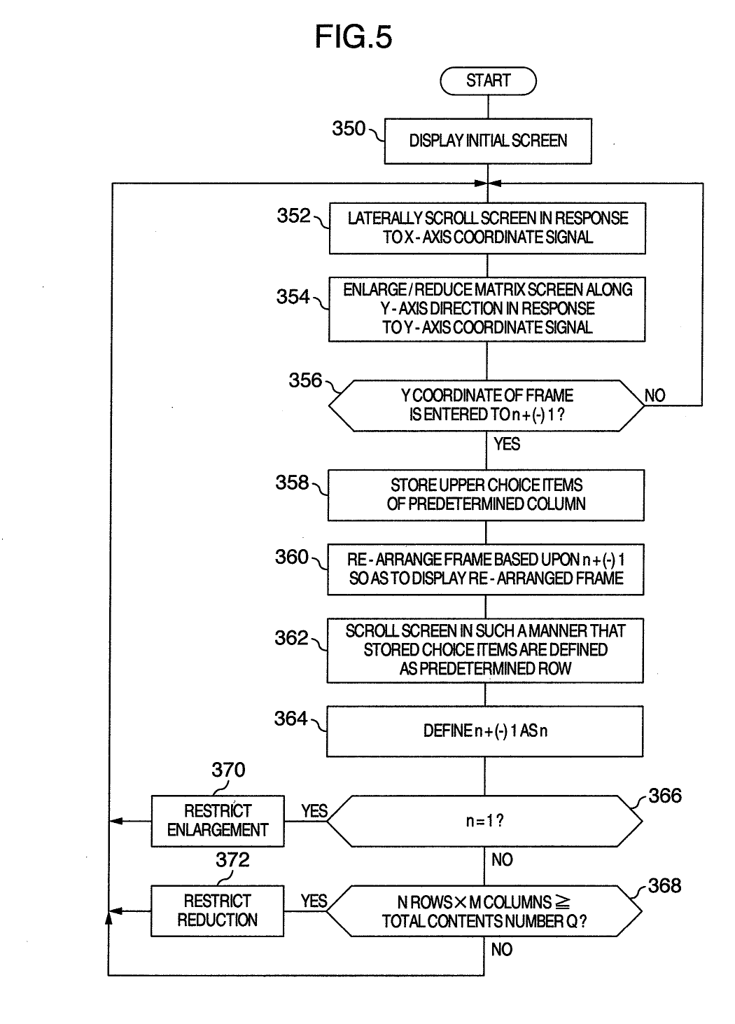

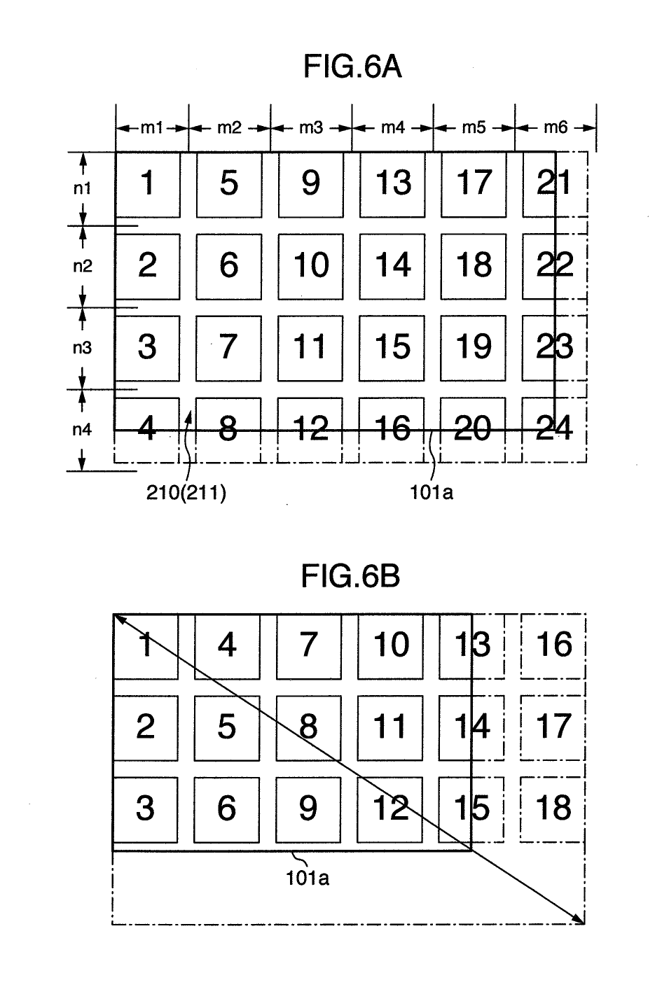

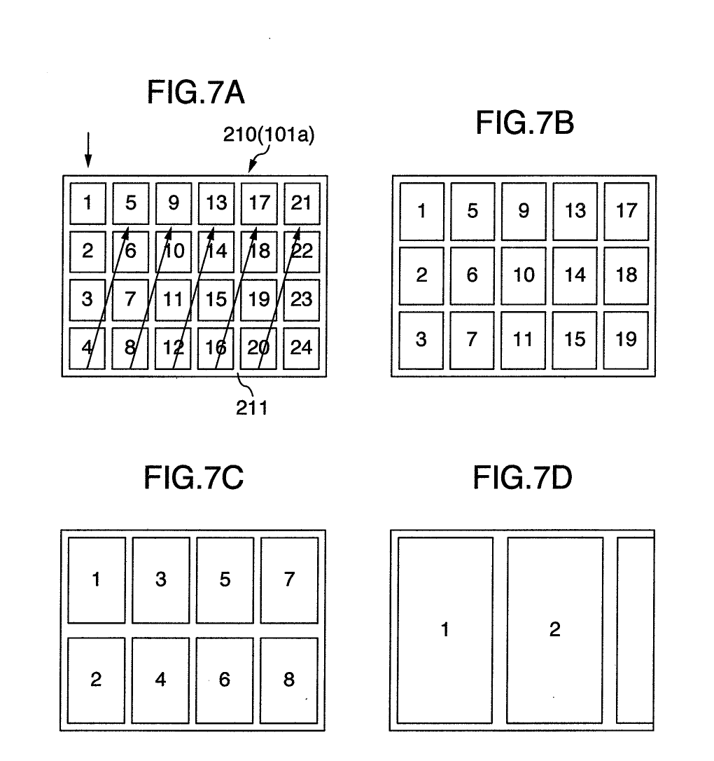

It should be understood that although a television receiver will be exemplified as one embodiment mode of the information display apparatus of the present invention in the below-mentioned description, the inventive idea of the present invention may be similarly applied to a personal computer, a game machine, and the like. In this case, FIG. 1 is a diagram for conceptionally showing the television receiver according to the first embodiment of the present invention. FIG. 2 is a block diagram for indicating an arrangement of the television receiver shown in FIG. 1. FIG. 3 is a flow chart for describing a contents retrieving flow operation of the television receiver of FIG. 1. FIG. 4 illustratively shows a contents retrieving screen of the television receiver of FIG. 1. FIG. 5 is a flow chart for describing a contents viewing flow operation of the television receiver of FIG. 1. FIG. 6A to FIG. 7D are array diagrams of contents viewing screens provided in the television receiver of FIG. 1.

Firstly, a description is made of a conceptional idea of the television receiver according to the first embodiment with reference to FIG. 1. In FIG. 1, the television receiver according to the first embodiment is arranged by a receiver main body 100 equipped with a display unit 101, and a remote controller 50 which enters various sorts of operations of this receiver main body 100. The receiver main body 100 may be realized as a most general-purpose integral body type television receiver in which the display unit 101 and a storage unit 102 (shown in FIG. 2) have been stored in a single housing, or may be alternatively realized as a display unit separation type housing structure in which the display unit 101 has been independently provided with respect to other apparatuses. In this example, the integral body type television receiver will now be exemplified. Also, the remote controller 50 corresponds to such a remote operation type operation instructing apparatus that a cursor displayed on the display unit 101 is operated by utilizing a track ball 51. In the first embodiment, the remote controller 50 will be explained by conducting such an example that a channel tuning operation and various sorts of operations can be remotely controlled by employing infrared signals, but the present invention is not limited only to this example. Alternatively, the remove operation type operation instructing apparatus may be equipped with a wireless apparatus, or may have such a construction for instructing an operation signal via a cord with respect to the receiver main body. Also, in the first embodiment, such an example will be described that the cursor is operated by employing a track ball. Alternatively, the cursor may be operated by a pointing device which is mounted on a remote controller, and which is operated by a finger tip of an operator under such a condition that this pointing device is gripped by a hand of the operator.

The above-described television receiver can view contents such as television broadcast programs by operating a tuner 103 (shown in FIG. 2) built in the receiver main body 100, and in addition, a control unit 111 built in the receiver main body 100 displays choice items 40 on a display screen 101a based upon an instruction operation issued from the remote controller 50, while the choice items 40 are made of a plurality of operation buttons and a plurality of icons, to which specific functions have been allocated, or made of photographic images and moving pictures. The control unit 111 moves the cursor based upon a coordinate positional signal constructed of X coordinates and Y coordinates, which is instructed by a track ball 51 with respect to these choice items 40, and then, the control unit 111 positions this cursor to a certain choice item. If the specific function has been allocated with respect to this selected choice item 40, then the control unit 111 can executes this allocated specific function.

Then, one of major features of the above-described television receiver is given as follows: That is, based upon operations of the remote controller 50 by utilizing the characteristics of the track ball 51, a list constructed by the plural choice items 40 is displayed on the display screen 101a; and upon receipt of a magnification instruction of this list display, an arranging operation of the choice items 40 designated by this magnification instruction is automatically carried out. In other words, in the first embodiment, while a value along the Y-axis direction of the track ball 51 has been defined as magnification, motion of the track ball 51 along the X-axis direction has been defined as a screen scroll operation along the Y-axis direction.

In such a case that the track ball 51 employed in the first embodiment is installed on a table, a wrist of an operator is put on one of arranging planes 52 of the track ball 51, and the operator manipulates the track ball 51 by her finger tip. In this case, as shown in FIG. 1(a), as to motion of the track ball 51 along front and rear directions (namely, Y-axis direction), since the finger of the operator is moved along the front and rear directions so as to manipulate the track ball 51, the motion range of this track ball 51 is restricted, so that the track ball 51 can be hardly manipulated. On the other hand, as represented in FIG. 1(b), motion of the track ball 51 along right and left directions (namely, X-axis direction) constitutes rotating operations while the wrist of the operator is set to a center, so that the operator can easily manipulate the track ball 11. In such a case that the operator manipulates the track ball 51 by her thumb while the operator grips the remote controller 50 by her one hand, similar operability of the track ball 51 to the above-described operability thereof may be achieved.

On the other hand, generally speaking, the display screen 101a has a laterally long shape in which a dimension of the longitudinal direction (Y-axis direction) is made longer than a dimension of the lateral direction (X-axis direction). Accordingly, the display screen 101a is suitably designed for the operability of the track ball 51. Also, in such a case that the plurality of choice items 40 are displayed in the list form so as to scroll the display screen 101a, it is also possibly understood that the screen scrolling operation along the lateral direction (X-axis direction) may be fitted to movement of human eyes, as compared with the movement along the upper/lower directions (Y-axis direction).

As a consequence, in the first embodiment, while movement of the track ball 51 along the Y-axis direction is accepted as magnification, an enlarging operation and a reducing operation are performed in a continuous manner in conjunction with a move amount of the track ball 51 along the Y-axis direction. Also, while movement of the track ball 51 along the X-axis direction is accepted as a screen scroll operation, the display screen 101a is scrolled in a continuous manner in conjunction with a move amount of the track ball 51 along the X-axis direction.

As previously described, in this first embodiment, the instruction for the magnification of the display screen 101a is accepted by the Y coordinates, and the instruction for the screen scroll operation along the right/left directions (X-axis direction) is accepted by the X coordinates in conjunction with the operation characteristic of the track ball 51, so that the operability can be improved.

Another idea of the major features of the above-described television receiver is given as follows: That is, an array is automatically changed in conjunction with magnification of enlargement/reduction. That is to say, in the first embodiment, in principle, the choice items 40 are arranged in a matrix constructed of “N” rows and “M” columns. In FIG. 1, a description has been made of such an example that a total number of these choice items 40 is 24. In this example, such a display mode that a list display made of 4 rows×6 columns is displayed on a single display screen 101a is defined as a list display of minimum magnification, and, conversely speaking, such a display mode that at least one piece of choice item 40 is displayed in a longitudinally full width of the display screen 101a is defined as maximum magnification. It should also be understood that although the above-defined minimum magnification and maximum magnification may be alternatively and furthermore set and/or reduced in larger magnification and/or smaller magnification, arrays thereof are not changed.

In order to realize this array, in the first embodiment, the choice items 40 are arranged in this order from the upper portion to the lower portion in the column of the matrix, and in this order from the left portion to the right portion in the row thereof. As a consequence, as indicated in FIG. 1, the choice items 40 are sequentially arranged from the upper portion to the lower portion in the left-sided row “m1”, and from the upper portion to the lower portion in the next left-sided row “m2.” Also, in an array change, while a row “n1” is set as a base point, it is so defined that the row number “N” is increased, or decreased in connection with a change in magnification.

Then, when the magnification is enlarged, so that a “choice item 4” of “n4m1” disappears from the display screen 101a, namely, when the lower end of the display screen 101a is entered to an area of “n3”, the control unit 111 moves the “choice item 4” of “n4m4” to a position of “n1m2”, and then, tries to re-arrange the subsequent choice items 40 in accordance with an arrow “P.” When the magnification is reduced, such a control operation is carried out in an opposite sense to the above-described control operation.

As previously explained, in the first embodiment, the “choice item 4” of “n4m4” which has disappeared from the display screen 101a in connection with the enlargement is re-arranged to the upper portion of the neighbor row “N.” As a result, the operator never forgets to see this “choice item 4.” Then, although these choice items 40 are virtually arrayed on the right side of the display screen 101a due to the re-arrangement, these virtually-arrayed choice items 40 may be displayed in a list form by moving the track ball 51 along the X-axis direction.

It should also be noted that in the above-described example of FIG. 1, this example has been exemplified in which the “choice item 1” could be viewed on the display screen 101a. For instance, in such an alternative case that more larger numbers of choice items 40 are provided and a display screen is scrolled, the display screen 101a may be scrolled in such a manner that the choice item 40 located at an upper portion of a predetermined row (namely, screen center) may be located at a predetermined row (screen center) which has been newly re-arranged. As a result, the choice item 40 which has disappeared from the display screen 101a due to the enlargement may be located on the right side of the predetermined row, which may mitigate such a problem that the operator forgets to see the disappeared choice item 40.

Referring now to FIG. 2 to FIG. 7D, the television receiver of the first embodiment will be described more in detail.

In FIG. 2, the remote controller 50 is equipped with a rotation sensing unit 55, a decision operation switch 56, and an operation button 57. The rotation sensing unit 55 is constituted by an X-axis sensing sensor unit 53 and an Y-axis sensing sensor unit 54, which sense a rotation of the track ball 51. The decision operation switch 56 senses a depression given to the track ball 51. In addition, the remote controller 50 is constructed by containing an infrared communication unit 58, a storage unit 59, a control unit 60, and a vibration driving unit 61. The infrared communication unit 58 transmits and/or receives infrared signals via the above-described infrared transmitting window. The storage unit 59 stores thereinto an operation program, an operation history, and the like. The control unit 60 controls operations of the remote controller 50 in a unification manner. The vibration driving unit 61 gives vibrations to the receiver main body 100 of the remote controller 50 based upon an instruction of the control unit 60.

On the other hand, the receiver main body 100 which is operated in response to an operation instruction issued from the remote controller 50 corresponds to a most general apparatus which is equipped with a display unit 101, a sound output unit 105, a tuner 103, a network communication unit 108, an infrared communication unit 109, a storage unit 110, and a control unit 111. The display unit 101 is employed in order to display thereon a menu screen and a list for operations. The sound output unit 105 is realized by a speaker, and the like. The tuner 103 is used to receive contents from an antenna 106. The network communication unit 108 is employed so as to acquire contents from the Internet 107 via a communication line. The infrared communication unit 109 is employed so as to transmit/receive infrared signals from the remote controller 50. The storage unit 110 stores thereinto various sorts of programs, contents, and the like. The control unit 111 controls the respective apparatuses employed in the receiver main body 100 in a unification manner.

It should also be understood that in the first embodiment, since the communication operations are carried out between the infrared communication unit 58 and the infrared communication unit 109 in a bidirectional manner, the signal can be received from the receiver main body 100, and thus, the signal reception can be notified via the vibration driving unit 61 to the user. Although in such a case that a force feedback is carried out, the bidirectional communication is required, whereas when the force feedback is not carried out, a unidirectional communication may be carried out from the remote controller 50 to the receiver main body 100. Also, in the first embodiment, the infrared communication has been employed. Instead of this infrared communication, wireless communication based upon electromagnetic waves may be alternatively employed.

Next, a description is made of a contents retrieving operation with reference to an operation flow chart of FIG. 3 and a screen image diagram of FIG. 4. In FIG. 3, when the control unit 111 of the receiver main body 100 according to this first embodiment accepts an operation of a menu bottom corresponding to one operation switch of the operation buttons 57 of the remote controller 50 (step 300), the control unit 111 displays a contents retrieving menu screen 200 indicated in FIG. 4 on the display screen 101a (step 302).

In this menu screen 200, a plurality of folders are arrayed in longitudinal columns, and a plurality of contents are displayed on a list display screen 210, while these contents belong to a folder selected in the above-described folder area 201. Then, one folder has been continuously brought into the selected status in the folder area 201. FIG. 4 represents such a condition that a folder “C” has been selected in the folder area 201.

When the control unit 111 monitors an operation signal of the track ball 51 and then accepts a move signal of the Y coordinates (step 306), a cursor 203 is moved over the folders displayed in the folder area 201 in the longitudinal column in response to the instruction of the Y coordinates (step 314). In this case, if the control unit 111 furthermore accepts a move instruction when the cursor 203 is located at either an upper end or a lower end, the control unit 111 is operated in order to perform a screen scroll operation. Then, the control unit 111 displays the contents belonging to the folder selected in the folder area 201 on the list display screen 210, and when the folder selection is changed in the folder area 201, the control unit 111 switches to display contents in response to this folder section.

On the other hand, when the control unit 111 accepts a move signal of the X coordinates (step 308), the control unit 111 laterally scrolls a contents list arrayed on the list display screen 210 along an instructed direction (step 316). A display area 204 is shown as one example of a display area of a laterally scroll screen.

Then, when the control unit 111 accepts a decision key operation issued from the remote controller 50 (step 310), the folder area 201 is brought into a non-display status, and the control unit 111 can execute the enlarging/reducing operation flow of the list display screen 210 (step 312).

Next, referring to FIG. 5 to FIG. 7D, a concrete description is made of enlarging/reducing operation flows of the list display screen 210. Firstly, a description is made of a feature of the list display screen 210 with reference to FIG. 6A and FIG. 6B. FIG. 6A shows an array of such a status that a display operation is moved from minimum magnification to an enlarging display, and FIG. 6B indicates an array of such a status that the display contents are further enlarged and then one row has been decreased therefrom.

In FIG. 5, when a display instruction of the list display screen 210 is issued from the operation step of FIG. 3, in step 350, the control unit 111 displays an initial screen of the list display screen 210 indicated in FIG. 6A.

In FIG. 6A and FIG. 6B, while this list display screen 210 is provided with a contents display area 211, a maximum display number “Q1” required in N rows M columns, namely, N rows×M columns can be displayed in this contents display area 211. For example, in the example of FIG. 6A and FIG. 6B, a total number of contents “Q2” is 24, and these 24 contents are displayed in a matrix made of 4 rows 6 columns (equal to maximum display number “Q1”) capable of displaying this total number of contents “Q2.” Then, such a display status that this matrix made of 4 rows 6 columns is displayed on the display screen 101a is defined as the minimum magnification. The control unit 111 calculates both the row number and the column number from the total contents number “Q2” of the contents selected in the folder area 201 so as to display the initial screen.

Returning back to FIG. 5, the control unit 111 accepts a coordinate signal produced by the track ball 51 of the remote controller 50; if the accepted coordinate signal is an X-axis coordinate signal, then the control unit 111 laterally scrolls the display screen 101a along the instruction direction (step 352); and if the accepted coordinate signal is a Y-axis coordinate signal, then the control unit 111 controls the display screen 101a as an enlarge, or reduce signal of the Y-axis direction (longitudinal direction) (step 354). However, if the magnification exceeds a predetermined value, namely if a total number of rows displayed on the display screen 101a is changed, the control unit 111 changes the array of the contents (step 356).

That is, in FIG. 6A and FIG. 6B, as indicated in FIG. 6A, when an enlarging instruction is received, the control unit 111 enlarges a display content in response to an instructed speed thereof. Since a relation between the display content and the display screen 101a is a correlative change, it is conceivable that an enlargement has the same meaning that a frame 101b of the display screen 101a is reduced. In this first embodiment, the control unit 111 has been set in such a manner that while the upper left point is defined as the base point, the enlarging/reducing operations are carried out. Accordingly, if the enlarging instruction is received and then a lower end of the frame 101b is entered from the area “n4” of the four rows into the area “n3” of the three rows, namely if a total number of rows to be displayed is decreased by 1 row, then the control unit 111 changes the matrix display array of 4 rows into another matrix display array of 3 rows in such a manner that, as shown in FIG. 4B, the “content 4” is moved from the position of “n4m1” to the position of “n1m2.” In this case, if a total number of rows is decreased, then a total number of columns is increased, which may be properly processed by scrolling the screen. Also, when a reduction display is performed, operations are carried out in an opposite sense to the above-described steps so as to execute such an operation for increasing a total number of rows.

FIG. 7A to FIG. 7D represent a change in display contents of the list display screen 210 in conjunction with a change in row numbers. As shown in FIG. 7A, when the total number of rows is changed, positions where the respective contents are displayed are successively changed. FIG. 7B represents an array of such a status that 1 row has been decreased from the status of the array shown in FIG. 7A. Furthermore, FIG. 7C indicates an array in such a case that a matrix is displayed by 2 rows. FIG. 7D shows a list display screen 210 of such a status that a matrix is displayed by 1 row. In this example, the status of FIG. 7A becomes minimum display magnification, and the status of FIG. 7D becomes maximum display magnification. It should also be noted that although the enlarge magnification and the reduction magnification may be further reduced from that of FIG. 7A, or may be further enlarged from that of FIG. 7D, the arrays are not changed.

Returning back to FIG. 5, as previously described, in a step 356, when the lower end of the frame 101b is increased/decreased from the present row area (step 356), a choice item (contents) of an upper portion of a predetermined column is stored (step 358). In this example of FIG. 6A and FIG. 6B, the choice item (contents 1) of the upper portion of the column “m1” is stored. Then, the control unit 111 re-arranges the list based upon the increased/decreased number of the row (step 360), and scrolls the display screen in such a manner that a choice item (contents) of a predetermined row may constitute a predetermined row (step 362).

In this example, although the contents viewing flow operation may be alternatively carried out while omitting the above-described steps 356 and 360, since these steps are provided, the content of the display screen may be more easily viewed. For instance, since a predetermined row to be stored is set to a center of the display screen 101a, even when the number of rows is changed and therefore the array is changed, such a content arrayed at the uppermost portion of the center is continuously present at the center. As a result, even when a large number of contents are present in the contents display area 211, a subject content is continuously located at the center, so that a stray content and confusion may be mitigated, which are caused by changing the array.

Thereafter, when the control unit 111 performs the above-described array change (step 364), the control unit 111 monitors whether or not a total number of rows is increased based upon the changed row number (step 366). Also, the control unit 111 has monitored both the maximum magnification and the minimum magnification. In other words, when the row number “n” is 1 row (step 366), the control unit 111 judges that the row number “n” cannot be furthermore enlarged, so that the control unit 111 restricts the enlargement of the row number (step 370). On the other hand, when the number of contents to be displayed is equal to, or exceeds a total contents number (step 368), the control unit 111 judges that the number of contents to be displayed cannot be furthermore reduced, so that the control unit 111 restricts the reduction of the number of contents to be displayed (step 372).

In the above-described first embodiment, the X coordinates have been defined as the screen scroll. Alternatively, the X coordinates may be defined as cursor movement within the contents display area 211. For instance, while a single content is continuously under selection status (cursor) within the contents display area 211, if the X coordinates are changed, then this cursor may be moved in accordance with an order of an array. In this alternative case, the content selected by the cursor is stored in the step 358, and then, in the step 362, the control unit 111 scrolls the display screen in such a manner that the selected content is positioned in the central row, or the selected content is positioned in the left-sided row from the central row when the selected content does not reach the central row. If this method is employed, then the following merits may be achieved: That is, in such a case that a specific function has been given to the selected content, since this specific function may be executed by operating the decision key, the content which has been under selection status by using the cursor may be applied not only to a preview for the list display screen 210, but also general-purpose contents retrieving operation.

As previously described, the information display apparatus such as the television receiver, according to the first embodiment of the present invention, is featured as a method for displaying an information display apparatus equipped with: a display apparatus (display unit) for displaying thereon a plurality of choice items in a list form; a control apparatus (control unit) for controlling an array of the choice items of the display apparatus; and a remote operation apparatus (remote controller) having a track ball for instructing a coordinate signal with respect to the control apparatus. In the method for displaying the information display apparatus, the plural choice items are displayed on the display apparatus in a matrix array constructed of N rows M columns in which the plural choice items are sequentially arranged from an upper portion to a lower portion of the matrix array, and also, along right/left directions thereof; magnification is changed based upon a coordinate signal of the track ball along a Y-axis direction; a display screen is scrolled along the right/left directions based upon a coordinates signal of the track ball along an X-axis direction; and the array is changed based upon a number of rows to be displayed in correspondence with an increased/decreased number of rows to be displayed in connection with the change of the magnification. Then, in the first embodiment, the display screen is scrolled in such a manner that a predetermined choice item before the array is changed may be arranged in a predetermined column displayed after the array has been changed.

Also, the information display apparatus such as the television receiver, according to another embodiment of the present invention, is featured as an information display apparatus equipped with: a display apparatus (display unit) for displaying thereon a plurality of choice items in a list form, to which specific functions have been allocated; a control apparatus (control unit) for controlling an array of the choice items of the display apparatus; and a remote operation apparatus (remote controller) having a track ball for instructing a coordinate signal with respect to the control apparatus. In the above-described information display apparatus, the plural choice items are displayed on the display apparatus in a matrix array constructed of N rows M columns in which the plural choice items are sequentially arranged from an upper portion to a lower portion of the matrix array, and also, along right/left directions thereof; magnification is changed based upon a coordinate signal of the track ball along a Y-axis direction; a selection of the choice items is accepted based upon a coordinates signal of the track ball along an X-axis direction; and the array is changed based upon a number of rows to be displayed in correspondence with an increased/decreased number of rows to be displayed in connection with the change of the magnification. Then, in this case, the display screen can be scrolled in such a manner that a predetermined choice item before the array is changed may be arranged in a predetermined column displayed after the array has been changed. Also, since a decision operation made from the remote operation apparatus is accepted, such a function may be executed which has been allocated to the choice item under selection.

### Second Embodiment

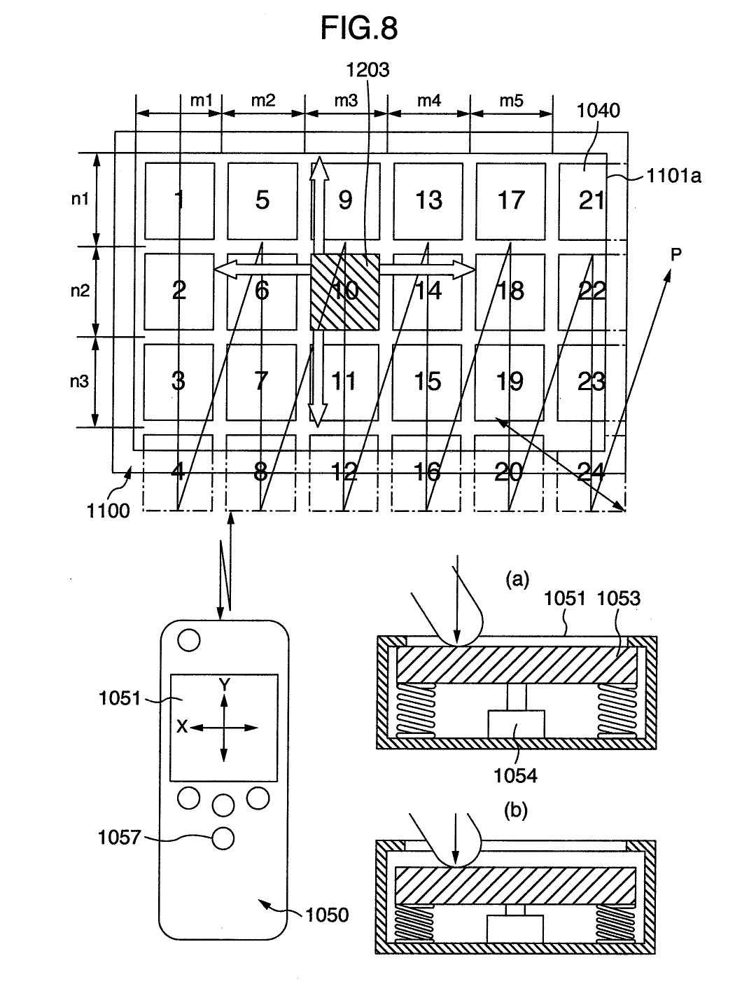

Referring now to FIG. 8 to FIG. 17D, a concrete description is made of an information display apparatus according to a second embodiment of the present invention.

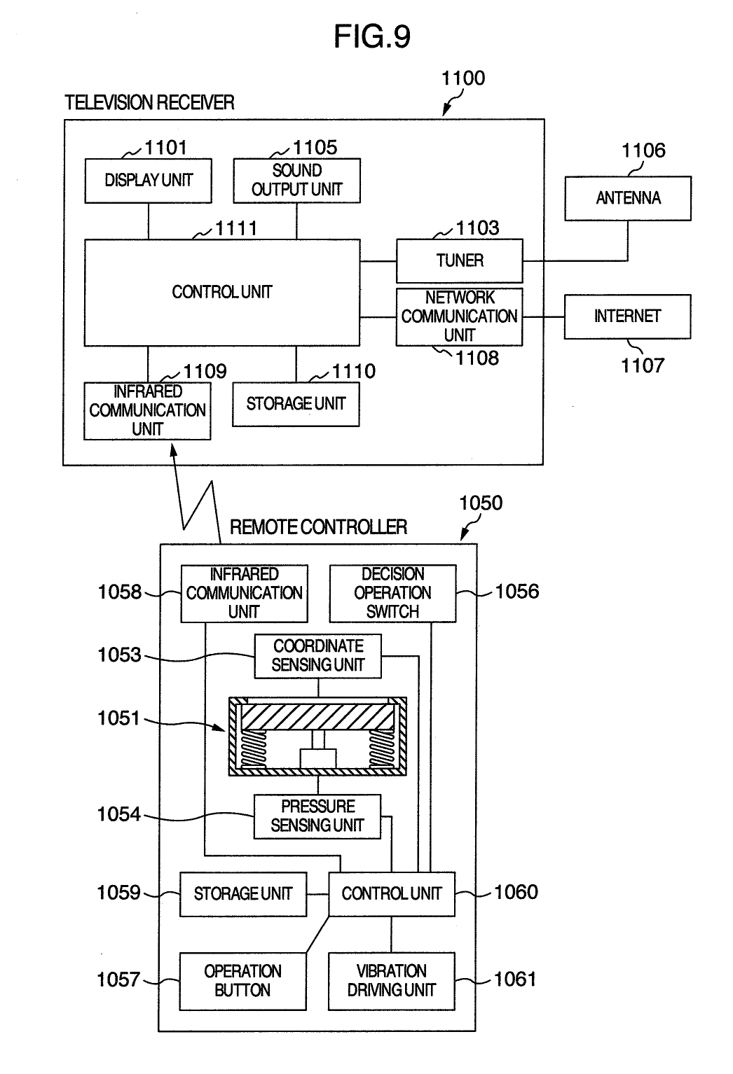

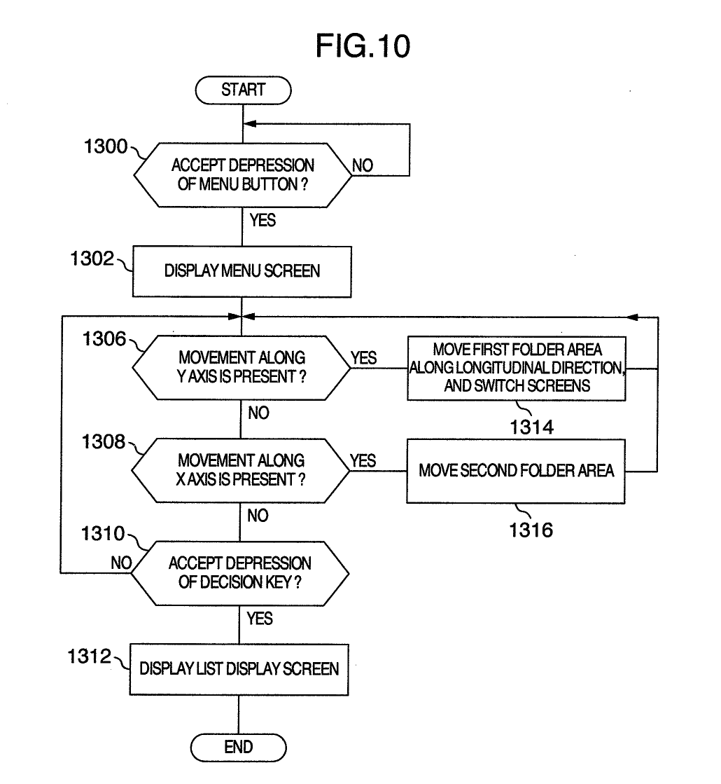

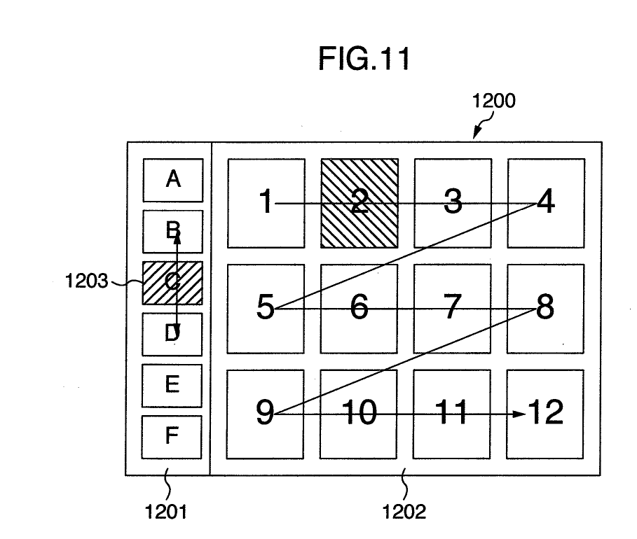

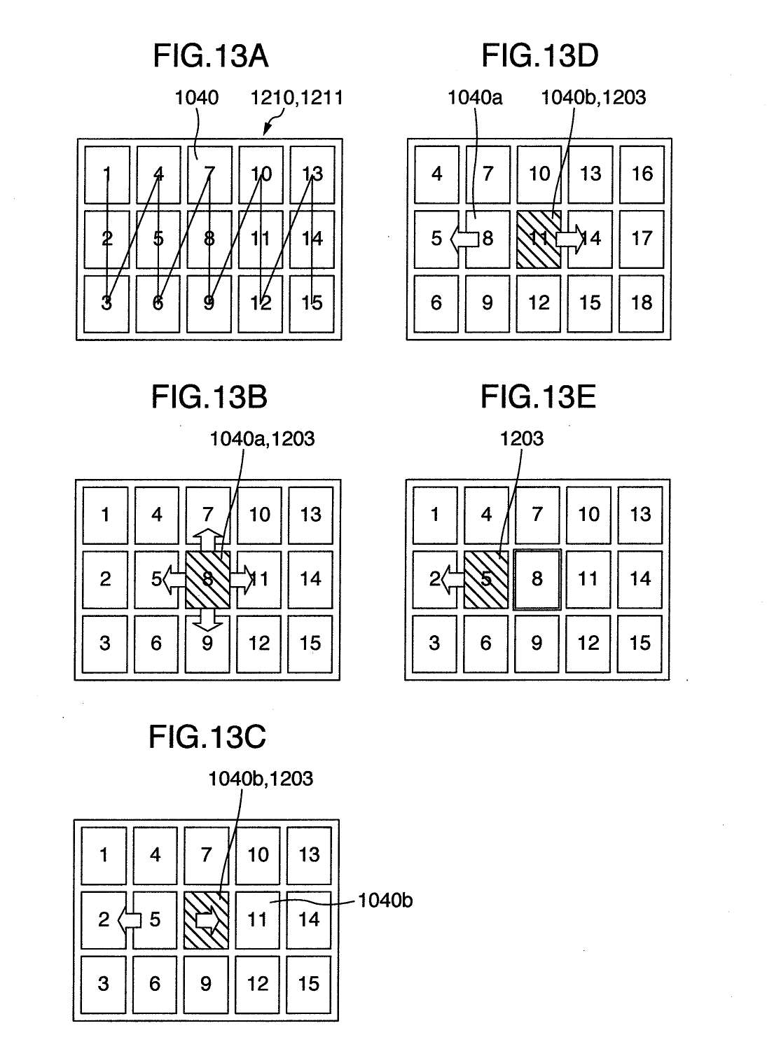

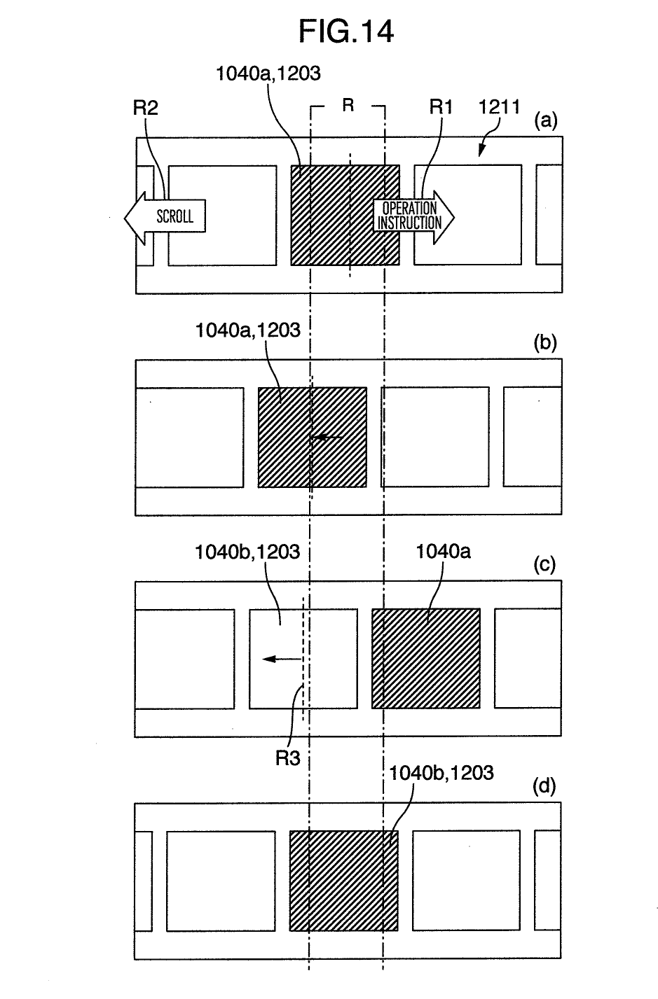

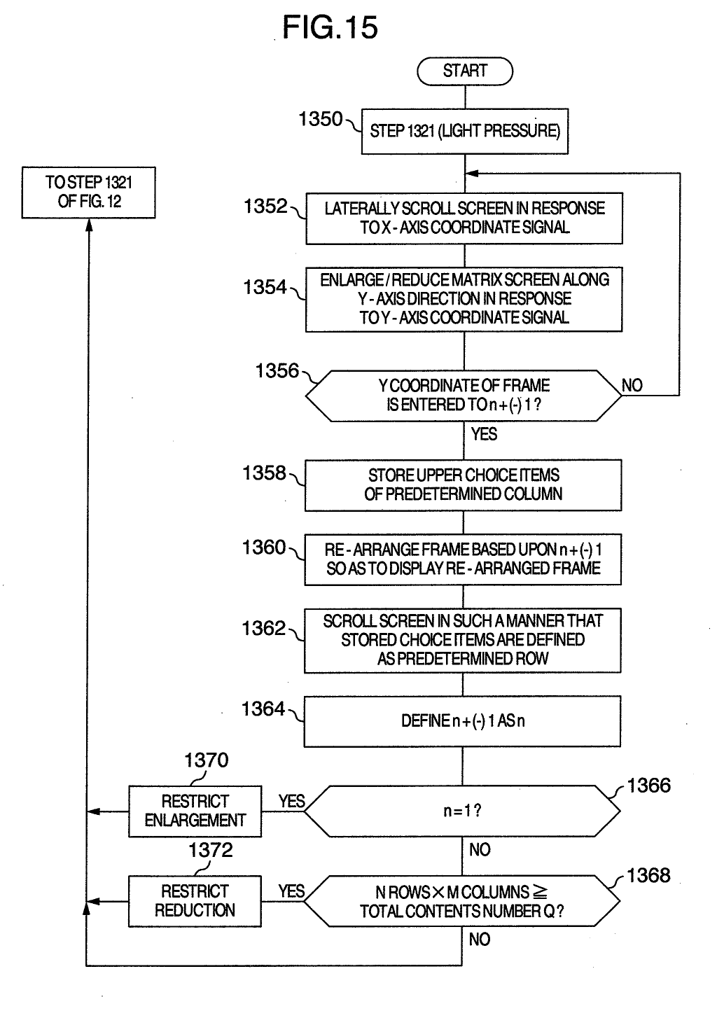

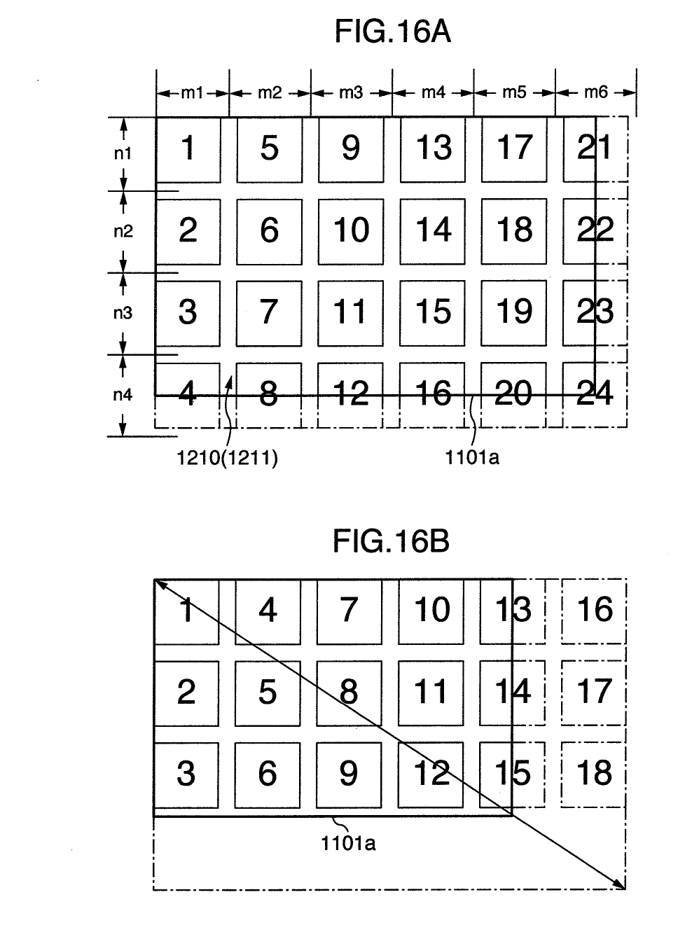

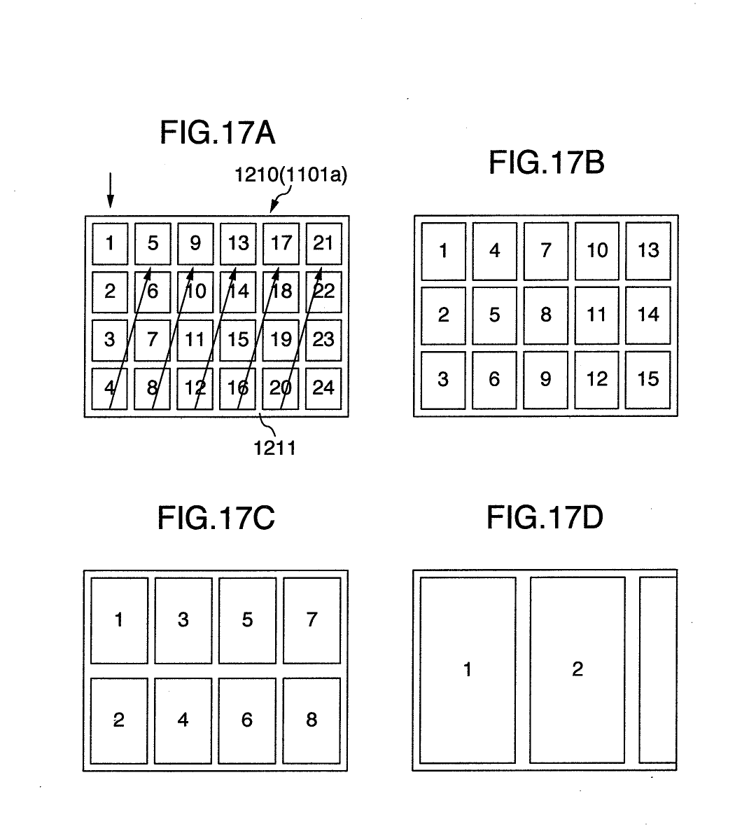

It should be understood that although a television receiver will be exemplified as one embodiment mode of the information display apparatus of the present invention in the below-mentioned description, the inventive idea of the present invention may be similarly applied to a personal computer, a game machine, and the like. In this case, FIG. 8 is a diagram for conceptionally showing the television receiver according to the second embodiment of the present invention. FIG. 9 is a block diagram for indicating an arrangement of the television receiver shown in FIG. 8. FIG. 10 is a flow chart for describing a contents retrieving flow operation of the television receiver of FIG. 8. FIG. 11 illustratively shows a contents retrieving screen of the television receiver of FIG. 8. FIG. 15 is a flow chart for describing a contents viewing flow operation of the television receiver of FIG. 8. FIG. 13A-FIG. 13E, FIG. 14, FIG. 16A-FIG. 16B, and FIG. 17A-FIG. 17D are array diagrams of contents viewing screens provided in the television receiver of FIG. 8.

Firstly, a description is made of a conceptional idea of the television receiver according to the second embodiment with reference to FIG. 8. In FIG. 8, the television receiver according to the second embodiment is arranged by a receiver main body 1100 equipped with a display unit 1101, and a remote controller 1050 which enters various sorts of operations of this receiver main body 1100. The receiver main body 1100 may be realized as a most general-purpose integral body type television receiver in which the display unit 1101 and a storage unit 1102 (shown in FIG. 9) have been stored in a single housing, or may be alternatively realized as a display unit separation type housing structure in which the display unit 1101 has been independently provided with respect to other apparatuses. In this example, the integral body type television receiver will now be exemplified.

Also, the remote controller 1050 corresponds to such a remote operation type operation instructing apparatus that a move selecting operation (move operation) for a focused status (selected status) displayed on the display unit 1101 is carried out by a touch pad unit 1051. In the second embodiment, the remote controller 1050 will be explained by conducting such an example that a channel tuning operation and various sorts of operations can be remotely controlled by employing infrared signals, but the present invention is not limited only to this example. Alternatively, the remove operation type operation instructing apparatus may be equipped with a wireless apparatus, or may have such a construction for instructing an operation signal via a cord with respect to the receiver main body. Also, in the second embodiment, such an example will be described that the selecting operation of the focused status is carried out by the touch pad unit 1051. Alternatively, the cursor may be operated by a pointing device which is mounted on a remote controller, and which is operated by a finger tip of an operator under such a condition that this pointing device is gripped by a hand of the operator.

The above-described television receiver can view contents such as television broadcast programs by operating a tuner 1103 (shown in FIG. 9) built in the receiver main body 1100, and in addition, a control unit 1111 built in the receiver main body 1100 displays choice items 1040 on a display screen 1101a based upon an instruction operation issued from the remote controller 1050, while the choice items 1040 are made of a plurality of operation buttons and a plurality of icons, to which specific functions have been allocated, or made of photographic images and moving pictures. The control unit 1111 moves the focused status based upon a coordinate positional signal constructed of X coordinates and Y coordinates, which is instructed by the touch pad unit 1051 with respect to these choice items 1040, and then, the control unit 1111 positions this focused status to a certain selected position. If the specific function has been allocated with respect to this selected choice item 1040, then the control unit 1111 can executes this allocated specific function.

Then, one of major features of the above-described television receiver is given as follows: That is, based upon operations of the remote controller 1050 equipped with the touch pad unit 1051 corresponding to a coordinate instructing apparatus, the plurality of choice items 1040 are displayed on the display screen 1101a in a list form; an array is changed in conjunction with magnification of this list display; and choice items 1040 being displayed in the list can be selected by instructing the touch pad unit 1051. In other words, as the touch pad unit 1051 related to this second embodiment, such a touch pad unit equipped with a pressure sensing unit 1054 capable of sensing touch pressure has been employed. Then, the control unit 1111 accepts a change of an array in connection with magnification of the list display in such an operation that the touch pad unit 1051 is touched with light pressure as shown in FIG. 8(a). Also, the control unit 1111 accepts a choice item 1040 of a focused status in the list display as moving operations along an X-axis direction and a Y-axis direction in such an operation that the touch pad unit 1051 is touched with heavy pressure as shown in FIG. 8(b).

In other words, in this second embodiment, coordinates instruction signals of the touch pad unit 1051 corresponding to the coordinates instruction apparatus are switched via a pressure sensing unit 1054 which constitutes a switching unit into a first mode and a second mode. In the first mode, magnification is changed based upon a coordinates signal of the Y-axis direction; a display screen is scrolled along right and left directions based upon a coordinates signal of the X-axis direction; and the array of the above-described list display is changed based upon a number of rows to be displayed in correspondence with increased/decreased numbers of the rows to be displayed in connection with the change in the magnification. In the second mode, while a choice item of a predetermined position in a previously set list display is defined as a focused status, the above-described focused status is moved based upon the coordinates signals of the X-axis direction and the Y-axis direction.

In accordance with the above-described feature, the present list display may be changed into such a list display having an easily observable dimension by touching the touch pad unit 1051 with the light pressure, and then, this touch pad unit 1051 is directly touched with the heavy pressure, so that a target choice item 1040 can be determined from the plural choice items displayed in this list display. In this case, when the heavy touching operation is accepted, such a choice item 1040 displayed at a predetermined position (home position) of the list display as indicated by a hatched line portion may be brought into the focused status, and this focused status may be moved by instructing the touch pad unit 1051.

In this second embodiment, such an example of the touch pad unit 1051 capable of sensing the applied pressure has been described. Alternatively, instead of the touch pad unit 1051, a coordinates instructing apparatus such as a track ball and a mouse, which are capable of determining both a move direction and a move amount, may be combined with such a switching unit such as an operation button which switches the move direction and the move amount into two operation instructions.

Another idea of the major features of the above-described television receiver is given as follows: That is, based upon operations of the remote controller 1050 equipped with the touch pad unit 1051, the plurality of choice items 1040 are displayed on the display screen 1101a; and an instruction of magnification as to this list display is accepted by the touch operation, and thus, the choice items 1040 instructed by the magnification are automatically carried out. In other words, in the second embodiment, while a value along the Y-axis direction of the touch pad unit 1051 has been defined as magnification, motion of the touch pad unit 1051 along the X-axis direction has been defined as a screen scroll operation along the Y-axis direction.

On the other hand, generally speaking, the display screen 1101a has a laterally long shape in which a dimension of the longitudinal direction (Y-axis direction) is made longer than a dimension of the lateral direction (X-axis direction). Also, in such a case that the plurality of choice items 1040 are displayed in the list form so as to scroll the display screen 1101a, it is also possibly understood that the screen scrolling operation along the lateral direction (X-axis direction) may be fitted to movement of human eyes, as compared with the movement along the upper/lower directions (Y-axis direction). As a consequence, in the second embodiment, while movement of the touch pad unit 1051 along the Y-axis direction is accepted as magnification, an enlarging operation and a reducing operation are performed in a continuous manner in conjunction with a move amount of the touch pad unit 1051 along the Y-axis direction. Also, while movement of the touch pad unit 1051 along the X-axis direction is accepted as a screen scroll operation, the display screen 1101a is scrolled in a continuous manner in conjunction with a move amount of the touch pad unit 1051 along the X-axis direction.

As previously described, in this second embodiment, the instruction for the magnification of the display screen 1101a is accepted by the Y coordinates, and the instruction for the screen scroll operation along the right/left directions (X-axis direction) is accepted by the X coordinates based upon the operation instruction of the touch pad unit 1051, so that the operability can be improved.

Another idea of the major features of the above-described television receiver is given as follows: That is, an array is automatically changed in conjunction with magnification of enlargement/reduction. That is to say, in the second embodiment, in principle, the choice items 1040 are arranged in a matrix constructed of “N” rows and “M” columns. In FIG. 8, a description has been made of such an example that a total number of these choice items 1040 is 24. In this example, such a display mode that a list display made of 4 rows×6 columns is displayed on a single display screen 1101a is defined as a list display of minimum magnification, and, conversely speaking, such a display mode that at least one piece of choice item 1040 is displayed in a longitudinally full width of the display screen 1101a is defined as maximum magnification. It should also be understood that although the above-defined minimum magnification and maximum magnification may be alternatively and furthermore set and/or reduced in larger magnification and/or smaller magnification, arrays thereof are not changed.

In order to realize this array, in the second embodiment, the choice items 1040 are arranged in this order from the upper portion to the lower portion in the column of the matrix, and in this order from the left portion to the right portion in the row thereof. As a consequence, as indicated in FIG. 8, the choice items 1040 are sequentially arranged from the upper portion to the lower portion in the left-sided row “m1”, and from the upper portion to the lower portion in the next left-sided row “m2.” Also, in an array change, while a row “n1” is set as a base point, it is so defined that the row number “N” is increased, or decreased in connection with a change in magnification.

Then, when the magnification is enlarged, so that a “choice item 4” of “n4m1” disappears from the display screen 1101a, namely, when the lower end of the display screen 1101a is entered to an area of “n3”, the control unit 1111 moves the “choice item 4” of “n4m4” to a position of “n1m2”, and then, tries to re-arrange the subsequent choice items 1040 in accordance with an arrow “P.” When the magnification is reduced, such a control operation is carried out in an opposite sense to the above-described control operation.

As previously explained, in the second embodiment, the “choice item 4” of “n4m4” which has disappeared from the display screen 1101a in connection with the enlargement is re-arranged to the upper portion of the neighbor row “N.” As a result, the operator never forgets to see this “choice item 4.” Then, although these choice items 1040 are virtually arrayed on the right side of the display screen 1101a due to the re-arrangement, these virtually-arrayed choice items 1040 may be displayed in a list form by moving the touch pad unit 1051 along the X-axis direction.

It should also be noted that in the above-described example of FIG. 8, this example has been exemplified in which the “choice item 1” could be viewed on the display screen 1101a. For instance, in such an alternative case that more larger numbers of choice items 1040 are provided and a display screen is scrolled, the display screen 1101a may be scrolled in such a manner that the choice item 1040 located at an upper portion of a predetermined row (namely, screen center) may be located at a predetermined row (screen center) which has been newly re-arranged. As a result, the choice item 1040 which has disappeared from the display screen 1101a due to the enlargement may be located on the right side of the predetermined row, which may mitigate such a problem that the operator forgets to see the disappeared choice item 1040.

Referring now to FIG. 9 to FIG. 17D, the television receiver of the second embodiment will be described more in detail.

In FIG. 9, the remote controller 1050 is equipped with the touch pad unit 1051 having both a coordinates sensing unit 1053 and a pressure sensing unit 1054; a decision operation switch 1056 for instructing a decision operation; and an operation button 1057. The coordinates sensing unit 1053 senses a touch operation, a move direction, and a move amount. The pressure sensing unit 1054 senses pressure applied to the touch pad. In addition, the remote controller 1050 is constructed by containing an infrared communication unit 1058, a storage unit 1059, a control unit 1060, and a vibration driving unit 1061. The infrared communication unit 1058 transmits and/or receives infrared signals via the above-described infrared transmitting window. The storage unit 1059 stores thereinto an operation program, an operation history, and the like. The control unit 1060 controls operations of the remote controller 1050 in a unification manner. The vibration driving unit 1061 gives vibrations to the receiver main body 1100 of the remote controller 1050 based upon an instruction of the control unit 1060.

On the other hand, the receiver main body 1100 which is operated in response to an operation instruction issued from the remote controller 1050 corresponds to a most general apparatus which is equipped with a display unit 1101, a sound output unit 1105, a tuner 1103, a network communication unit 1108, an infrared communication unit 1109, a storage unit 1110, and a control unit 1111. The display unit 1101 is employed in order to display thereon a menu screen and a list for operations. The sound output unit 1105 is realized by a speaker, and the like. The tuner 1103 is used to receive contents from an antenna 1106. The network communication unit 1108 is employed so as to acquire contents from the Internet 1107 via a communication line. The infrared communication unit 1109 is employed so as to transmit/receive infrared signals from the remote controller 1050. The storage unit 1110 stores thereinto various sorts of programs, contents, and the like. The control unit 1111 controls the respective apparatuses employed in the receiver main body 1100 in a unification manner.

It should also be understood that in the second embodiment, since the communication operations are carried out between the infrared communication unit 1058 and the infrared communication unit 1109 in a bidirectional manner, the signal can be received from the receiver main body 1100, and thus, the signal reception can be notified via the vibration driving unit 1061 to the user. Although in such a case that a force feedback is carried out, the bidirectional communication is required, whereas when the force feedback is not carried out, a unidirectional communication may be carried out from the remote controller 1050 to the receiver main body 1100. Also, in the second embodiment, the infrared communication has been employed. Instead of this infrared communication, wireless communication based upon electromagnetic waves may be alternatively employed.

Next, a description is made of a contents retrieving operation with reference to an operation flow chart of FIG. 10 and a screen image diagram of FIG. 11. In FIG. 10, when the control unit 1111 of the receiver main body 1100 according to this second embodiment accepts an operation of a menu bottom corresponding to one operation switch of the operation buttons 1057 of the remote controller 1050 (step 1300), the control unit 1111 displays a contents retrieving menu screen 1200 indicated in FIG. 11 on the display screen 1101a (step 1302).

In this menu screen 1200, a plurality of folders are arrayed in longitudinal columns, and a plurality of contents are displayed on a list display screen 1202, while these contents belong to a folder selected in the above-described folder area 1201. Then, one folder has been continuously brought into the selected status in the folder area 1201. FIG. 11 represents such a condition that a folder “C” has been selected in the folder area 1201.

When the control unit 1111 monitors an operation signal of the touch pad unit 1051 and then accepts a move signal of the Y coordinates (step 1306), a focused status 1203 is moved over the folders displayed in the folder area 1201 in the longitudinal column in response to the instruction of the Y coordinates (step 1314). In this case, if the control unit 1111 furthermore accepts a move instruction when the focused status 1203 is located at either an upper end or a lower end, the control unit 1111 is operated in order to perform a screen scroll operation. Then, the control unit 1111 displays the contents belonging to the folder selected in the folder area 1201 on the list display screen 1202, and when the folder selection is changed in the folder area 1201, the control unit 1111 switches to display contents in response to this folder section.

On the other hand, when the control unit 1111 accepts a move signal of the X coordinates (step 1308), the control unit 1111 laterally scrolls a contents list arrayed on the list display screen 1202 along an instructed direction (step 1316).

Then, when the control unit 1111 accepts a decision key operation issued from the remote controller 1050 (step 1310), the folder area 1201 is brought into a non-display status; such a list display screen 1210 (indicated in FIG. 11) is displayed in which the list display screen 1202 has been represented in an enlarging manner; and the choice items 1040 related to the retrieved contents are displayed on this list display screen 1210 in a list form, so that an enlarging/reducing operation flow for this list display can be carried out (step 1312).

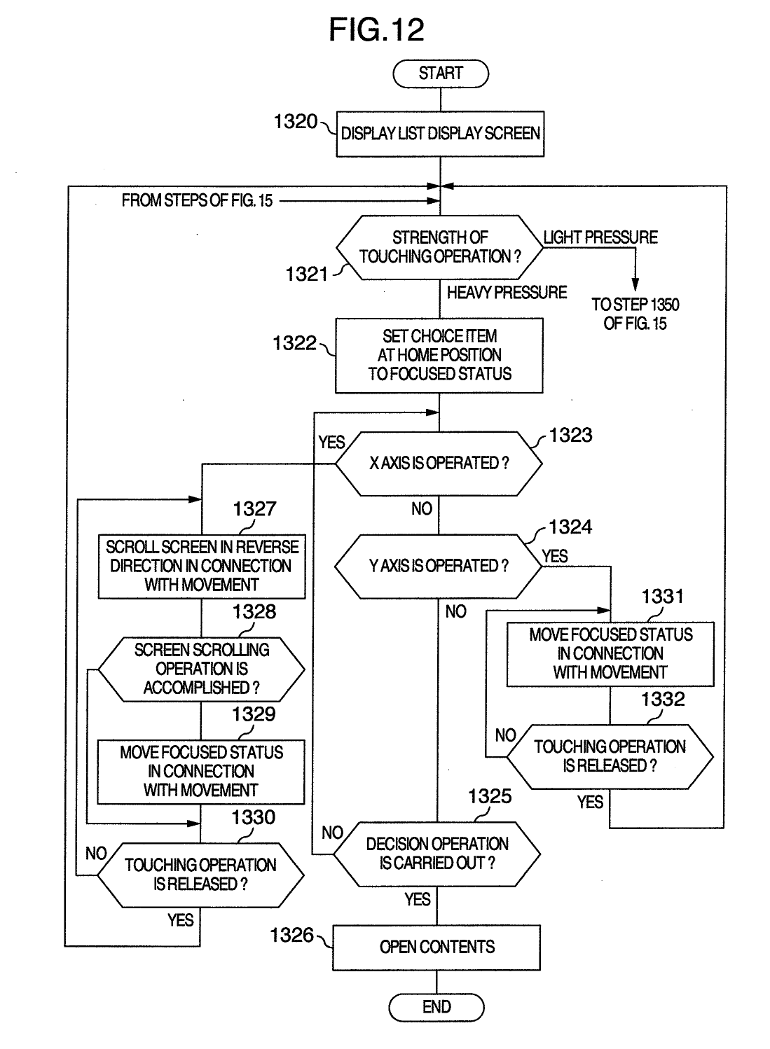

Next, referring to screen transition diagrams of FIG. 13A to FIG. 13E, FIG. 14, FIG. 16A to FIG. 16B, and FIG. 17A to FIG. 17D, a concrete description is made of a selecting flow operation, and an enlarging/reducing flow operation with respect to the choice items 1040 of the list display screen 1210 based upon operation flow charts shown in FIG. 12 and FIG. 15.

First of all, the selecting flow operation for the choice items 1040 will now be described with reference to FIG. 12, FIG. 13A to FIG. 13E, and FIG. 14.

In FIG. 12, when the control unit 1111 accepts an operation of the decision key from the remote controller 1050 in operations of the menu screen 1200, the control unit 1111 displays such a list display screen 1210 on the display unit 1101, in which the choice items 1040 related to contents under focused status 1203 are displayed in a list form (step 1320). As shown in FIG. 13A, while this list display screen 1210 is provided with a contents display area 1211, the choice items 1040 constructed of “N rows M columns” have been arrayed in this order from an upper portion to a lower portion of the left column, and in this order from an upper portion to a lower portion of the next left column in accordance with a preset sequence.

When the control unit 1111 has already displayed the list screen display screen 1210, the control unit 1111 is monitoring whether or not a touching operation of the touch pad unit 1051 has been performed with stronger pressure than a preset reference value (step 1321). Then, when the control unit 1111 judges that the touch pad unit 1051 has been touched with light pressure (step 1321), the process operation is advanced to a step 1352 indicated in FIG. 15. When the control unit 1111 judges that the touch pad unit 1051 has been touched with heavy pressure, as represented in FIG. 13B, the control unit 1111 brings such a choice item “1040a” located at a preset home position (for example, center of display screen) into a focused status 1203 (step 1322). Then, the control unit 1111 monitors whether or not an operation of the X axis has been carried out (step 1323), or monitors whether or not an operation of the Y axis has been carried out (step 1324), or monitors whether or not the decision operation has been carried out (step 1325) under this condition that the touch pad unit 1051 has been touched with heavy pressure. In other words, if the touch pad unit 1051 is touched with heavy pressure, the focused status 1203 appears at the home position; if the touch pad unit 1051 is rub-operated under this status, then the focused status 1203 is moved along the rubbing direction; and then, the function allocated to this choice item 1040a can be executed by performing a decision operation.

Now, when an operation along the X axis is carried out via the touch pad unit 1051, for example, as shown in FIG. 13C, if the control unit 1111 accepts a move operation along the right side direction by operating the touch pad unit 1051, then the control unit 1111 causes the focused status 1203 to be moved in connection with the move operation along the right side direction by the touch pad unit 1051 as represented in FIG. 13D based upon the below-mentioned manner (step 1327): That is, the control unit 1111 scrolls the screen so as to move the display of the contents display area 1211 along such a direction opposite to the instruction direction by the touch pad unit 1051; and when the choice item 1040a of the focused status 1203 has left the home position, the control unit 1111 determines another choice item 1040b which subsequently comes to the home position as the focused status 1203. A description is made of such an operation for scrolling the screen while this home position is maintained with reference to FIG. 14.

In FIG. 14(a), in the second embodiment, the home position has been set at a predetermined position of the contents display area 1211 within a predetermined range (lateral width). In other words, the home position provided with a range of a lateral width “R” has been set at a center of the contents display area 1211 along the X-axis direction. When an operation instruction “R1” for the right side direction is issued by the touch pad unit 1051, the screen is scrolled along a right side “R2” opposite to the operation instruction “R1” within the contents display area 211. In this case, as shown in FIG. 14(b), a choice item 41a of the focused status 1203 is moved in accordance with the screen scrolling operation “R2.”However, as indicated in FIG. 14(c), if a center “R3” of the choice item 1040a exceeds the range of the home position, then the choice item 1040b which will be subsequently moved to the home position is set as the focused status 1203, and this choice item 1040b is moved to the left side “R2” as shown in FIG. 14(d). Thereafter, since the above-described movement is repeated, the choice item 1040 is successively brought into the focused status 1203 in accordance with the operation instruction “R1” issued by the touch pad unit 1051 along the right side direction.

Returning back to FIG. 12, when the array of the choice item 1040 reaches an end position, the final choice item 1040 cannot be brought into the focused status 1203 in the operation for maintaining the home position. As a consequence, in this second embodiment, as shown in FIG. 13E, when the move operation to the left side along the X-axis direction is continued, the control unit 1111 monitors whether or not the screen scrolling operation has been accomplished (step 1328). When the screen scrolling operation has been accomplished, the control unit 1111 moves the focused status 1203 along the coordinates instruction direction (namely, left side direction) of the touch pad unit 1051 (step 1329). When the screen scrolling operation has not yet been accomplished, the process operation bypasses the above-described step 1329 and then is advanced to a step 1330. Then, in this step 1330, the control unit 1111 monitors whether or not the touching operation of the touch pad unit 1051 has been released. When the touching operation has been released, the process operation is returned to the step 1321. When the touching has not yet been released, the process operation is returned to the step 1327.

On the other hand, when the Y axis is operated by the touch pad unit 1051 in the step 1327, the control unit 1111 moves the focused status 1203 to an instruction direction of the Y axis in correspondence with the above-described move direction (step 1331). In a step 1332, the control unit 1111 judges whether or not the touching operation is released. If the touching operation is released, then the process operation is returned to the step 1321, whereas when the touching operation is not released, the control unit 1111 continuously executes the process operation of the step 1331.

Then, when the control unit 1111 judges that a decision operation has been made in a step 1325, the control unit 1111 executes such an operation for opening a content (step 1326), namely the function allocated to the choice item 1040.

Next, referring to FIG. 15 to FIG. 17D, a concrete description is made of enlarging/reducing operation flows of the list display screen 1210. Firstly, a description is made of a feature of the list display screen 1210 with reference to FIG. 16A and FIG. 16B. FIG. 16A shows an array of such a status that a display operation is moved from minimum magnification to an enlarging display, and FIG. 16B indicates an array of such a status that the display contents are further enlarged and then one row has been decreased therefrom.

In FIGS. 16A and 16B, the control unit 1111 accepts an operation of the decision key from the remote controller 1050 in an operation of the menu screen 1200, the control unit 1111 displays such a list display screen 1210 that the choice items 1040 related to the contents under the focused status 1203 are displayed in the list form, on the display unit 1101.

While this list display screen 1210 is provided with a contents display area 1211, a maximum display number “Q1” required in N rows M columns, namely, N rows×M columns can be displayed in this contents display area 1211. For example, in the example of FIG. 16A and FIG. 16B, a total number of contents “Q2” is 24, and these 24 contents are displayed in a matrix made of 4 rows 6 columns (equal to maximum display number “Q1”) capable of displaying this total number of contents “Q2.” Then, such a display status that this matrix made of 4 rows 6 columns is displayed on the display screen 1101a is defined as the minimum magnification. The control unit 1111 calculates both the row number and the column number from the total contents number “Q2” of the contents selected in the folder area 1201 so as to display the initial screen.

Returning back to FIG. 15 in step 1350, the control unit 1111 accepts a coordinate signal produced by touching in light pressure the touch pad unit 1051 of the remote controller 1050; if the accepted coordinate signal is an X-axis coordinate signal, then the control unit 1111 laterally scrolls the display screen 1101a along the instruction direction (step 1352); and if the accepted coordinate signal is a Y-axis coordinate signal, then the control unit 1111 controls the display screen 1101a as an enlarge, or reduce signal of the Y-axis direction (longitudinal direction) (step 1354). However, if the magnification exceeds a predetermined value, namely if a total number of rows displayed on the display screen 1101a is changed, the control unit 1111 changes the array of the contents (step 1356).

That is, in FIG. 13A to FIG. 13E, as indicated in FIG. 13A, when an enlarging instruction is received, the control unit 1111 enlarges a display content in response to an instructed speed thereof. Since a relation between the display content and the display screen 1101a is a correlative change, it is conceivable that an enlargement has the same meaning that a frame 1101b of the display screen 1101a is reduced. In this second embodiment, the control unit 1111 has been set in such a manner that while the upper left point is defined as the base point, the enlarging/reducing operations are carried out. Accordingly, if the enlarging instruction is received and then a lower end of the frame 1101b is entered from the area “n4” of the four rows into the area “n3” of the three rows, namely if a total number of rows to be displayed is decreased by 1 row, then the control unit 1111 changes the matrix display array of 4 rows into another matrix display array of 3 rows in such a manner that, as shown in FIG. 13B, the “content 4” is moved from the position of “n4m1” to the position of “n1m2.” In this case, if a total number of rows is decreased, then a total number of columns is increased, which may be properly processed by scrolling the screen. Also, when a reduction display is performed, operations are carried out in an opposite sense to the above-described steps so as to execute such an operation for increasing a total number of rows.

FIG. 17A to FIG. 17D represent a change in display contents of the list display screen 1210 in conjunction with a change in row numbers. As shown in FIG. 17A, when the total number of rows is changed, positions where the respective contents are displayed are successively changed. FIG. 17B represents an array of such a status that 1 row has been decreased from the status of the array shown in FIG. 17A. Furthermore, FIG. 17C indicates an array in such a case that a matrix is displayed by 2 rows. FIG. 17D shows a list display screen 1210 of such a status that a matrix is displayed by 1 row. In this example, the status of FIG. 17A becomes minimum display magnification, and the status of FIG. 17D becomes maximum display magnification. It should also be noted that although the enlarge magnification and the reduction magnification may be further reduced from that of FIG. 17A, or may be further enlarged from that of FIG. 17D, the arrays are not changed.

Returning back to FIG. 15, as previously described, in a step 1356, when the lower end of the frame 1101b is increased/decreased from the present row area (step 1356), a choice item (contents) of an upper portion of a predetermined column is stored (step 1358). In this example of FIG. 16A and FIG. 16B, the choice item (contents 1) of the upper portion of the column “m1” is stored. Then, the control unit 1111 re-arranges the list based upon the increased/decreased number of the row (step 1360), and scrolls the display screen in such a manner that a choice item (contents) of a predetermined row may constitute a predetermined row (step 1362).

In this example, although the contents viewing flow operation may be alternatively carried out while omitting the above-described steps 1356 and 1360, since these steps are provided, the content of the display screen may be more easily viewed. For instance, since a predetermined row to be stored is set to a center of the display screen 1101a, even when the number of rows is changed and therefore the array is changed, such a content arrayed at the uppermost portion of the center is continuously present at the center. As a result, even when a large number of contents are present in the contents display area 1211, a subject content is continuously located at the center, so that a stray content and confusion may be mitigated, which are caused by changing the array.

Thereafter, when the control unit 1111 performs the above-described array change (step 1364), the control unit 1111 monitors whether or not a total number of rows is increased based upon the changed row number (step 1366). Also, the control unit 1111 has monitored both the maximum magnification and the minimum magnification. In other words, when the row number “n” is 1 row (step 1366), the control unit 1111 judges that the row number “n” cannot be furthermore enlarged, so that the control unit 1111 restricts the enlargement of the row number (step 1370). On the other hand, when the number of contents to be displayed is equal to, or exceeds a total contents number (step 1368), the control unit 1111 judges that the number of contents to be displayed cannot be furthermore reduced, so that the control unit 1111 restricts the reduction of the number of contents to be displayed (step 1372).

As previously described, the information display apparatus such as the television receiver, according to the second embodiment of the present invention, is featured as follows: That is, based upon the operations of the coordinates instructing apparatus such as the touch pad unit 1051, the large amounts of choice items 1040 are displayed in the list form in such a magnification that these choice items 1040 can be easily viewed; the target choice item is selected from this list display; and therefore, the function allocated to the target choice item can be simply executed.

It should be further understood by those skilled in the art that although the foregoing description has been made on embodiments of the invention, the invention is not limited thereto and various changes and modifications may be made without departing from the spirit of the invention and the scope of the appended claims.

1. A display method of an information display apparatus comprising: a display apparatus for displaying thereon a plurality of choice items in a list form; a control apparatus for controlling an array of the choice items of said display apparatus; and a remote operation apparatus equipped with a track ball for instructing a coordinate signal with respect to said control apparatus; wherein:
said choice items are displayed on said display apparatus in a matrix array constructed of N rows M columns in which said choice items are sequentially arranged from an upper portion to a lower portion of said matrix array, and further, along right and left directions thereof;
magnification is changed based upon a coordinate signal of said track ball along a Y-axis direction;
a display screen of said display apparatus is scrolled along the right/left directions based upon a coordinate signal of said track ball along an X-axis direction; and
said matrix array is changed based upon a number of rows to be displayed in correspondence with increased/decreased numbers of the rows to be displayed in connection with the change in said magnification.

2. The display method of an information display apparatus as claimed in claim 1 wherein:
the display screen is scrolled in such a manner that a predetermined choice item before the array is changed is arranged in a predetermined column displayed after the array is changed so as to display said predetermined choice item.

3. The display method of an information display apparatus as claimed in claim 1 wherein:
specific functions have been allocated to said plurality of choice items.

4. The display method of an information display apparatus as claimed in claim 3 wherein:
specific functions have been allocated to said plurality of choice items so as to display said predetermined choice item.

5. The display method of an information display apparatus as claimed in claim 3 wherein:
upon receipt of a decision operation made from said remote operation apparatus, the function allocated to said selected choice item is executed.

6. A display method of an information display apparatus comprising: a display apparatus for displaying thereon a plurality of choice items in a list form; a control apparatus for controlling an array of the choice items of said display apparatus; and a remote operation apparatus equipped with a pointing device for instructing a coordinate signal with respect to said control apparatus, said pointing device being operated by a finger tip of a user under gripped condition thereof; wherein:
said choice items are displayed on said display apparatus in a matrix array constructed of N rows M columns in which said choice items are sequentially arranged from an upper portion to a lower portion of said matrix array, and further, along right and left directions thereof;
magnification is changed based upon a coordinate signal of said pointing device along a Y-axis direction;
a display screen of said display apparatus is scrolled along the right/left directions based upon a coordinate signal of said pointing device along an X-axis direction; and
said matrix array is changed based upon a number of rows to be displayed in correspondence with increased/decreased numbers of the rows to be displayed in connection with the change in said magnification.

7. The display method of an information display apparatus as claimed in claim 6 wherein:
the display screen is scrolled in such a manner that a predetermined choice item before the array is changed is arranged in a predetermined column displayed after the array is changed so as to display said predetermined choice item.

8. A display method of an information display apparatus in which a plurality of choice items are displayed on a display screen in a list form in a matrix array constructed of N rows M columns in which said choice items are sequentially arranged from an upper portion to a lower portion of said matrix array, and further, along right and left directions thereof; and based upon an operation instruction issued from a coordinate instructing apparatus, a specific choice item is selected from said plurality of choice items displayed in the list form; wherein:
upon receipt of an operation signal of switching unit which switches coordinate signals of said coordinate instructing apparatus into a first mode and a second mode,
in the first mode, magnification is changed based upon a coordinate signal of a Y-axis direction; said display screen is scrolled along right/left directions based upon a coordinate signal of an X-axis direction; and an array of said list display is changed based upon a number of rows to be displayed in correspondence with increased/decreased numbers of the rows to be displayed in connection with the change in said magnification; and
in said second mode, while said choice item at a predetermined position of a preset list display is brought into a focused status, said focused status is moved based upon the coordinate signals of the Y-axis direction and the X-axis direction.

9. The display method of an information display apparatus as claimed in claim 8 wherein:
said coordinate instructing apparatus is a touch pad, said switching unit is a pressure sensing device for sensing touch pressure applied to said touch pad; and
said switching unit switches said first mode and said second mode by checking whether or not a sensed value of said pressure sensing device exceeds previously set pressure.

10. The display method of an information display apparatus as claimed in claim 8 wherein:
upon receipt of a decision operation made from said decision operating means, the function previously allocated to said choice item under the focused status is executed.

11. The display method of an information display apparatus as claimed in claim 9 wherein:
upon receipt of a decision operation made from said decision operating means, the function previously allocated to said choice item under the focused status is executed.
